(19) United States
(12) Patent Application Publication
(10) Pub. No.: US 2022/0339884 A1
(43) Pub. Date: Oct. 27, 2022

(54) DETERMINING WHETHER TO PRINT A THREE-DIMENSIONAL PRINT JOB

(71) Applicant: HEWLETT-PACKARD DEVELOPMENT COMPANY, L.P., Spring, TX (US)

(72) Inventors: Sergio GONZALEZ MARTIN, Sant Cugat del Valles (ES); Pablo DOMINGUEZ PASTOR, Sant Cugat del Valles (ES); Jordi TORRES BACARDI, Sant Cugat del Valles (ES); Alex CARRUESCO LLORENS, Sant Cugat del Valles (ES)

(21) Appl. No.: 17/763,151

(22) PCT Filed: Oct. 24, 2019
(86) PCT No.: PCT/US2019/057867

§ 371 Date: Mar. 23, 2022

(51) Int. Cl. B29C 64/393; B29C 64/153

(52) U.S. Cl. CPC B29C 64/393; B29C 64/153; B33Y 50/02

(57) ABSTRACT

A method (2 analyses (4) a layer of a three-dimensional print job wherein the value of a parameter relating to the processing time of the layer is determined. The method (2) determines (6) whether the layer of the three-dimensional print job is to be printed in a three-dimensional printer. This determination is based on the value of the parameter relating to processing time.

### BACKGROUND

Additive manufacturing machines produce 3D objects by building up layers of material. Some additive manufacturing machines are commonly referred to as “3D printers”. 3D printers and other additive manufacturing machines make it possible to convert a CAD (computer aided design) model or other digital representation of an object into the physical object. The model data may be processed into slices each defining that part of a layer or layers of build material to be formed into the object. Build material may comprise any suitable form of build material, for example fibres, granules or powders. The build material can include thermoplastic materials, ceramic material and metallic materials.

### BRIEF DESCRIPTION OF THE DRAWINGS

Some non-limiting examples of the present disclosure will be described in the following with reference to the appended drawings in which:

FIG. 1 is a flow diagram showing a method of determining whether to print a three-dimensional print job in a three-dimensional printer according to an example;

FIG. 2 is a schematic view of a system according to an example;

FIG. 3 is a schematic cross-sectional side view of a print job having layers determined as complex according to an example; and

FIG. 4 is a schematic cross-sectional side view of the print job of FIG. 3 after having been modified to avoid having complex layers according to an example.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

In some additive manufacturing processes, a binder agent is used to bind together particles of a powdered build material to form a solid object or part. Printing begins with a process of spreading the powdered build material on to the surface of a print area. A powder bed is thereby provided which covers a printing zone. Binder agent is then jetted at precise locations on to the powder bed to define the geometry of the single or multiple parts to be printed. The process then continues with an energy source assisting with the evaporation of liquid components. This process is repeated until the part or parts are formed layer by layer.

The process is undertaken by an additive manufacturing machine having, for example, two carriages. The first carriage has a roller or spreader that spreads the powder on the top of the print area surface to thereby provide successive layers of powder bed covering a build platform. The second carriage has a print nozzle and energy emitter. The print nozzle jets binder agent at precise locations on to the powder bed to define the geometry of the single or multiple parts to be printed. The energy emitter assists with the evaporation of liquid components of the binder agent.

In a different example, the process is undertaken by an additive manufacturing machine having one carriage which performs the functions of the two carriages mentioned above. These functions are performed in the same single pass of the carriage over the print area. In a yet further example having one carriage, the functions are performed in more than one pass of the carriage.

A three-dimensional print job is generated from a user generated file. The user generated file is parsed into separate parts to be printed and a bounding box for each separate part is generated which includes geometry compensation to correct distortions arising during the additive manufacturing process. Each part is associated with a single bounding box and each bounding box is associated with a single part. The bounding box for each part is defined by two points relative to a datum (each point having x, y and z coordinates). The two points define a minimum sized box containing all of the associated part and which is aligned with the X, Y and Z axes. As a consequence of the alignment with the X, Y and Z axes, the cross-section of a boundary box in the XY plane is the same irrespective of the Z axis coordinate. The three-dimensional print job includes the bounding boxes for all the parts to be printed.

By analysing a two-dimensional image of a layer of a three-dimensional print job to be printed, a processor of the additive manufacturing machine processes the three-dimensional print job and determines print instructions indicating precisely when binder or fusing agent is to be deposited as the carriage moves over the layer of build material. This determination is completed on a layer by layer basis immediately before each layer is jetted with agent. The process of spreading powder and depositing agent is to be completed in the same fixed period of time irrespective of the layer, and so the time available for the analysis to be completed is limited. For some layers, this available time may not be sufficient for the processor of the additive manufacturing machine to complete the analysis of the layer to determine precisely when agent is to be deposited. These layers have an adverse effect on the additive manufacturing process and can result in reduced print quality.

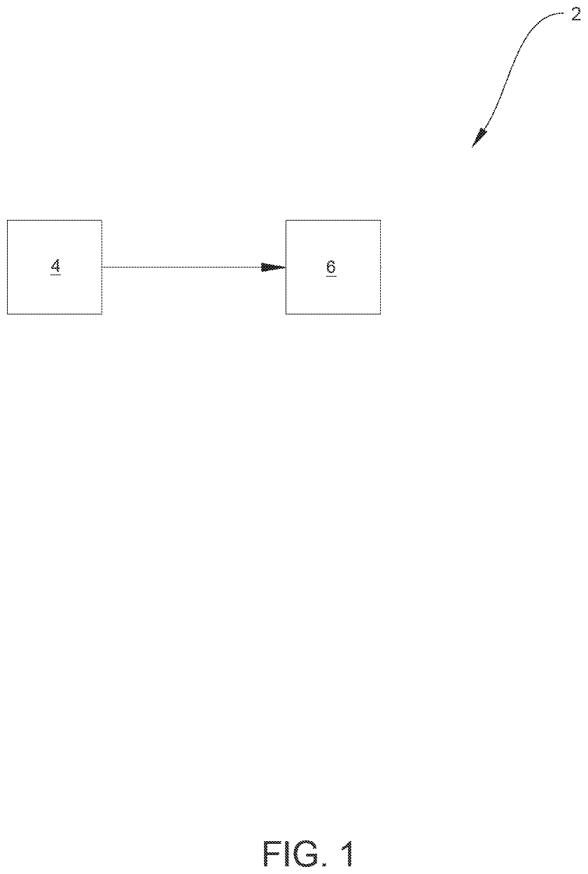

The geometry of a bounding box of a part at the intersection of a layer (i.e. in the XY plane) may result in the time taken for the processor to process that layer (the processing time) to be greater than the time available. Such a layer is deemed to be too complex to be printed with the required quality. This will be the case if the size of the area of the part bounding box, or of the combined areas of part bounding boxes, at the intersection of a layer (i.e. in the XY plane) is too great. As shown in FIG. 1 of the accompanying drawings, in an example of the present disclosure, a method 2 analyses 4 a layer of a three-dimensional print job wherein the value of a parameter relating to the processing time of the layer is determined. The method 2 determines 6 whether the layer of the three-dimensional print job is to be printed in a three-dimensional printer, wherein this determination is based on the value of the parameter relating to processing time.

The method allows a determination to be made as to whether to print a three-dimensional print job in a three-dimensional printer. This determination can be made before the printer begins to print the print job. So, if the method 2 determines that one or more layers of the print job is too complex such that, for example, those layers (referred to as complex layers) cannot be processed in time prior to the carriage operating to dispense binder agent on to the layers, then an informed decision can be made to not proceed with printing. In this way, it is possible to avoid wasting time and build material in printing a print job which will have reduced print quality as a result of the print job having complex layers.

Determining 6 whether the layer of the three-dimensional print job is to be printed includes generating comparison data by comparing the parameter value determined for the layer with a predetermined threshold value.

The comparison data is generated for each layer of the three-dimensional print job by comparing the parameter value determined for each layer with the predetermined threshold value, and, based on the comparison data, determining whether each layer of the three-dimensional print job is to be printed in a three-dimensional printer.

The method further includes identifying and recording the layers determined as being layers not to be printed in a three-dimensional printer. The recorded layers may be identified by, for example, first numbering all of the layers uniquely. Then, the numbers of those layers which are determined as being layers which are not to be printed is then recorded. These layers may be presented to a user by, for example, listing the layer numbers on a display screen. The listed numbers may be presented as layers which are not to be printed, or as layers which will or are likely to have a processing time which is too great.

The parameter of a layer is based on a comparison of (i) the total printable area in the layer, and (ii) the total area in the layer of all bounding boxes for parts to be printed in the layer for a given three-dimensional print job. The total printable area in the layer is the maximum area that could be printed (i.e. where a discontinuous sheet layer would be printed). The total area in the layer of all bounding boxes for parts to be printed in the layer is the sum of areas of all the part bounding boxes intersecting the layer. Any one layer in a print job may be intersected in one or more locations in the layer by a single part but the area used to determine the parameter is the area of the bounding box for that part which intersects the layer in question. If a print job includes more than one part, then one or more bounding box for these parts may intersect a layer at one or more locations in the layer. The cross-sectional area (i.e. in the XY plane) of a part bounding box intersecting with a layer is summed with the cross-sectional area (i.e. in the XY plane) of all other part bounding boxes intersecting with the same layer. This provides the total area in the layer of all bounding boxes for parts to be printed (i.e. jetted with binder agent) in that particular layer.

The total area of bounding boxes intersecting with a layer affects the time for a processor to analyse the layer prior to printing. The greater the total area, the greater the time for a processor to analyse the layer prior to printing.

In an example of the present disclosure, the parameter of a layer is the ratio of (i) the total printable area in the layer, to (ii) the total area in the layer of all bounding boxes for parts to be printed in the layer for a given three-dimensional print job. A layer of the three-dimensional print job is determined as being too complex to print in a three-dimensional printer when the parameter of the layer is less than three (other values are possible in other examples, as disclosed herein). In this case, the parameter will be three when the total printable area in a layer is exactly three times the total area of all bounding boxes in the layer for a given three-dimensional print job. If the total area to be printed in a layer increases so that the total printable area in a layer is less than three times the total area of all bounding boxes for parts to be printed in the layer, then the method determines the layer to be a complex layer, i.e. a layer too complex to be printed.

The predetermined threshold value determines whether the processing time for a layer is too great to be printed. The value of the predetermined threshold depends on various factors. For example, the value of the predetermined threshold depends on the processing speed of the processor in the printer 14 and on the print resolution in the layer (which itself is dependent upon the build material being used). The value of the predetermined threshold can also depend on the type of operations being performed to model different performance characteristics relating to printing fluids.

The present disclosure provides a system with a controller to perform the method described above. The system may be incorporated into a three-dimensional printer. The system may be remote and separate to a three-dimensional printer. Also, the present disclosure provides a non-transitory computer-readable medium having instructions, which when executed on a computing device, cause the computing device to perform the method described above. This medium may be incorporated into the system described above.

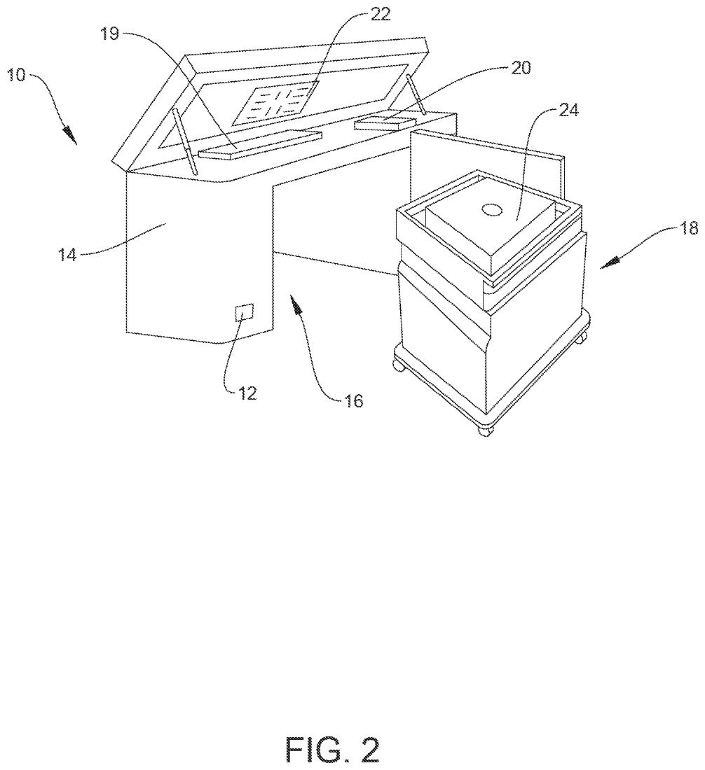

In an example of the present disclosure, a system 10 is provided as shown in FIG. 2 of the accompanying drawings.

The system 10 includes a controller 12 to analyse a layer of a three-dimensional print job wherein the value of a parameter relating to the processing time of the layer is determined. Based on the value of the parameter relating to processing time, the controller 12 determines whether the layer of the three-dimensional print job is to be printed in a three-dimensional printer.

The system 10 is a three-dimensional printer 14 having a build chamber 16 to receive a mobile build unit 18, a spreader 19 movable across the build chamber 16, a printhead 20 movable across the build chamber 16, and a printer heater 22 to heat the build chamber 16. The build unit 18 is locatable in and removable from the build chamber 16. The build unit 18 has a build platform 24 to receive build material (not shown).

In use of the printer 14 and build unit 18, a three-dimensional object or part is formed by the printer 14 depositing successive layers of build material on to the build platform 24. The build unit 18, in which the build platform 24 is provided, controls a vertical movement of the build platform 24. Each new layer is built on top of the previous layer. During this additive manufacturing process, the build platform 24 moves downward step-by-step in defined increments corresponding to the layer thickness to give room for the next layer of build material.

The spreader 19 and printhead 20 are mounted on separate carriages (not shown), which are configured to move back and forth in one dimension across a plane parallel to and above the build platform 24. The spreader 19 moves in a dimension perpendicular to the dimension in which the printhead 20 moves. The spreader 19 moves across the entire build platform 24 and spreads the build material into a layer on top of the build platform 24. The layers are heated by printer heater 22.

After one build material layer has been formed, the printhead 20 moves over the entire build platform 24 and deposits a fusing agent on to the layer in a pattern based on a cross-section of the object or part to be formed. Fusing energy is applied uniformly across the layer of build material. Those portions of the build material on which fusing agent has been applied absorb more fusing energy than those portions on which no fusing agent was applied and hence heat up more quickly, and fuse. After each layer is deposited and fused, the platform is lowered step-by-step, in increments corresponding to one layer advance.

Each layer is formed in this way in accordance with the three-dimensional print job.

When the printhead 20 jets fusing agent on to the layer of build material, the carriage on which the printhead 20 is mounted moves at a constant speed and so passes from one side of the build material layer to other in a fixed period of time. This period of time does not change from layer to layer, irrespective of how much fusing agent is to be deposited on to the build material. Indeed the time available for each cycle in the repeating process of spreading powder and depositing fusing agent (i.e. the process of spreading and fusing each layer) is the same fixed period for all layers.

In the system 10, in order to determine whether a layer of the three-dimensional print job is not to be printed, the controller 12 is configured to generate comparison data by comparing the parameter value determined for the layer with a predetermined threshold value. The controller 12 is configured to generate comparison data for each layer of the three-dimensional print job by comparing the parameter value determined for each layer with the predetermined threshold value. Based on the comparison data, the controller 12 determines whether each layer of the three-dimensional print job is not to be printed in the printer 14.

The parameter of a layer is based on a comparison of (i) the maximum area in the layer which is printable, and (ii) the sum of each area of bounding box in the layer for each part to be printed in the layer for a given three-dimensional print job. In the present example, the parameter of a layer is the ratio of (i) the total printable area in the layer, to (ii) the total area in the layer of all bounding boxes for parts to be printed in the layer for a given three-dimensional print job. A layer of the three-dimensional print job is determined as being a layer not to be printed in the three-dimensional printer 14 when the parameter of the layer is less than a predetermined threshold value of four. The threshold value in this example is greater than in the previous example of FIG. 1, where the threshold value is three. The greater threshold value may be a consequence of the processor being slower.

The parameter will have a value of four when the total printable area in a layer is exactly four times the total area of all bounding boxes for parts to be printed in the layer for a given three-dimensional print job. If the total printable area in a layer is less than four times the total area of all bounding boxes for parts to be printed, then the method determines the layer to be a complex layer and therefore likely to result in reduced print quality.

The controller 12 of printer 14 is configured to amend the three-dimensional print job in response to a determination that the three-dimensional print job has a layer which is not to be printed in the three-dimensional printer 14. The amendment to the three-dimensional print job is made to reduce the processing time of the layer which is not to be printed. The amendment to the three-dimensional print job may be made by amending the spacing between objects or parts defined in the three-dimensional print job to be printed.

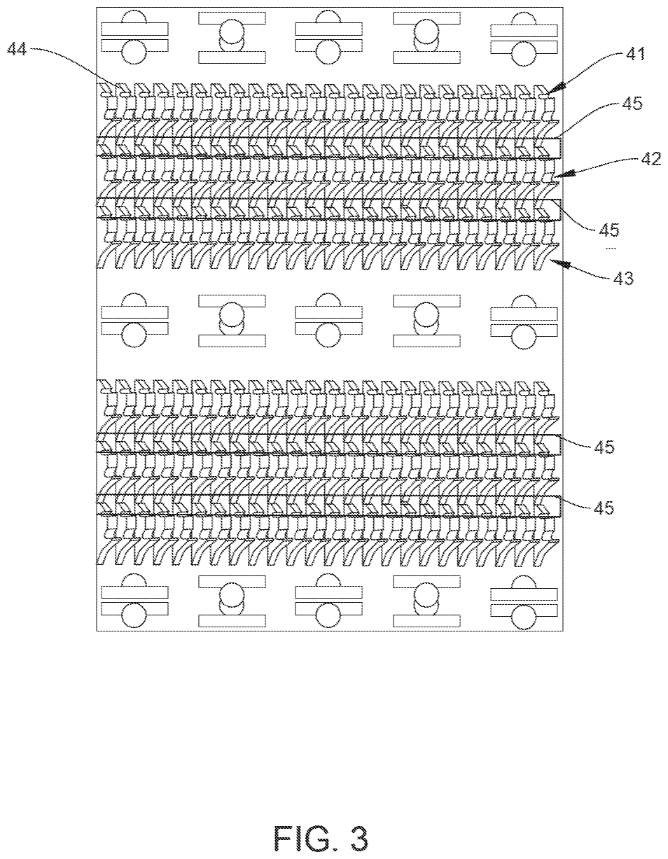

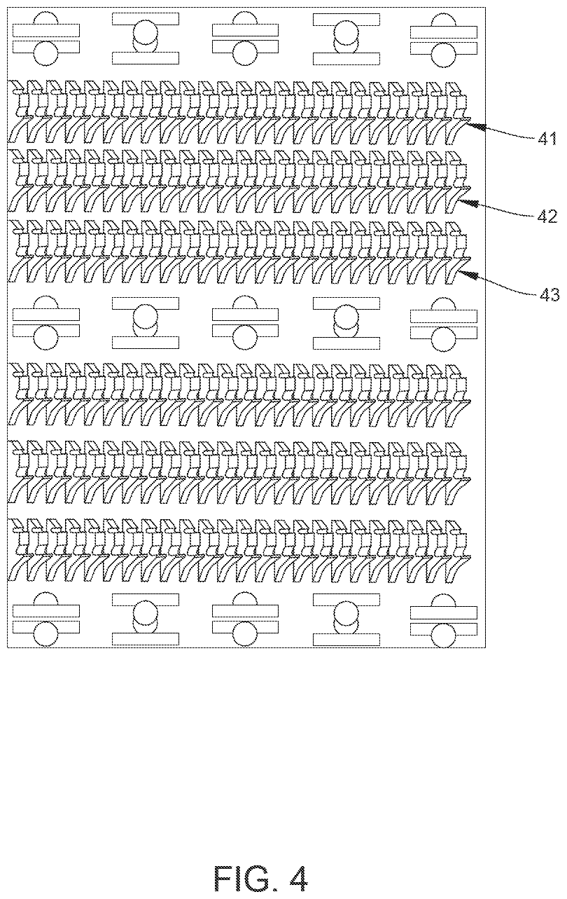

FIGS. 3 and 4 of the accompanying drawings show an example of a print job with complex layers (see FIG. 3) and how remedial action can be taken to amend the print job so as to avoid complex layers (see FIG. 4). FIGS. 3 and 4 show a side view of a print job.

In FIG. 3, three rows 41,42,43 of parts 44 are shown located one above each other. Each row includes three hundred parts. Neighbouring rows have a degree of overlap with one another, as highlighted by imaginary boxes 45, and in the overlapping region, the total number of parts intersecting a layer is six hundred. This results in the total printable area in a layer being less than four times the total area of all bounding boxes for parts to be printed. Accordingly, the controller 12 determines the layers in the imaginary boxes 45 to be complex layers which will result in reduced quality when printing the print job.

In FIG. 4, the print job has been amended so as to space apart the rows 41,42,43 of parts 44 and thereby remove the overlapping region. In this way, the amended print job results in the total printable area for any layer being less than four times the total area of all bounding boxes for parts to be printed in the layer. As a result, the amended print job does not include any complex layers and is printable in the printer 14.

In an example of the present disclosure, the controller 12 determines those layers which are not to be printed (as described above) and indicates these layers to a user. The user then makes an amendment to the print job (for example, as shown in FIG. 4) so that the processing time for the indicated layers is reduced to within the time available for processing a layer. The amendment can be suggested by the controller 12 to the user, and the user may then selects that amendment. A plurality of amendments can be suggested by the controller 12 from which one of the amendments may be selected by the user. The user may select an option for the controller 12 to automatically select an amendment so that the processing time for the indicated layers is reduced to within the time available for processing a layer.

In an example, rather than amending a print job so as to avoid complex layers, action can be taken to pre-process the three-dimensional print job in response to a determination that the three-dimensional print job has a layer which is not to be printed in a three-dimensional printer. The print job is pre-processed in that the complex layers are processed before printing begins, so that the analysis involved in processing the layers which are not to be printed is not time limited. In this way, printing instructions for the identified complex layers are generated and cached before printing commences.

In another example, rather than amending a print job so as to avoid complex layers, the time provided for processing all layers is increased (within the confines of providing acceptable print quality) or the time provided for processing simple layers is reduced so as to compensate for the longer time for complex layers (again, within the confines of providing acceptable print quality).

Once remedial action has been taken (for example, the print job has been amended or complex layers have been pre-processed), the print job is printed in the printer 14.

In another example of the present disclosure, the controller 12 is separate from the printer 14. In an example, the controller 12 automatically selects the predetermine threshold based on the build material being used. In an example, the controller 12 automatically selects the predetermine threshold based on the processor in the printer. The build material and processor being used can be automatically detected and related data provided to the controller 12.

When the printing process is complete, a mass of fused and unfused powder (“build volume” or “cake”) is present on the build platform 24. This volume of powder is post-processed (including being cooled in a controlled way) and unfused powder is removed allowing recovery of the formed 3D objects or parts.

Build material may comprise any suitable form of build material, for example short fibres, granules or powders. A powder may include short fibres that may, for example, have been cut into short lengths from long strands or threads of material. The build material can include thermoplastic materials, ceramic material and metallic materials. Binder agents may include chemical binder systems, such as in binder jet or metal type 3D printing. Binder or fusing agents may be used as appropriate.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited by the claims and the equivalents thereof.

1. A method to determine whether to print a three-dimensional print job in a three-dimensional printer, the method comprising:
analysing a layer of a three-dimensional print job wherein the value of a parameter relating to the processing time of the layer is determined; and
based on the value of the parameter relating to processing time, determining whether the layer of the three-dimensional print job is to be printed in a three-dimensional printer.

2. The method claimed in claim 1, wherein determining whether the layer of the three-dimensional print job is to be printed comprises generating comparison data by comparing the parameter value determined for the layer with a predetermined threshold value.

3. The method claimed in claim 2, wherein comparison data is generated for each layer of the three-dimensional print job by comparing the parameter value determined for each layer with the predetermined threshold value, and, based on the comparison data, determining whether each layer of the three-dimensional print job is to be printed in a three-dimensional printer.

4. The method claimed in claim 3, further comprising identifying and recording the layers determined as being layers to be printed in a three-dimensional printer.

5. The method claimed in claim 1, wherein the three-dimensional print job compensates for the occurrence of dimensional changes anticipated during post-processing.

6. The method claimed in claim 1, wherein each part is provided with a bounding box, and wherein the parameter of a layer is based on a comparison of (i) the total printable area in the layer, and (ii) the total area in the layer of all bounding boxes for parts to be printed in the layer for a given three-dimensional print job.

7. The method claimed in claim 1, wherein each part is provided with a bounding box, and wherein the parameter of a layer is the ratio of (i) the total printable area in the layer, to (ii) the total area in the layer of all bounding boxes for parts to be printed in the layer for a given three-dimensional print job.

8. A system comprising a controller to:
analyse a layer of a three-dimensional print job wherein the value of a parameter relating to the processing time of the layer is determined; and
based on the value of the parameter relating to processing time, determine whether the layer of the three-dimensional print job is to be printed in a three-dimensional printer.

9. The system of claim 8, wherein to determine whether the layer of the three-dimensional print job is to be printed, the controller is configured to generate comparison data by comparing the parameter value determined for the layer with a predetermined threshold value.

10. The system of claim 9, wherein the controller is configured to:
generate comparison data for each layer of the three-dimensional print job by comparing the parameter value determined for each layer with the predetermined threshold value; and
based on the comparison data, determine whether each layer of the three-dimensional print job is to be printed in a three-dimensional printer.

11. The system of claim 10, wherein each part is provided with a bounding box, and wherein the parameter of a layer is based on a comparison of (i) the maximum area in the layer which is printable, and (ii) the sum of each area of bounding box in the layer for each part to be printed in the layer for a given three-dimensional print job.

12. The system of claim 10, wherein the controller is configured to:
amend the three-dimensional print job in response to a determination that the three-dimensional print job has a layer which is not to be printed in a three-dimensional printer, the amendment to the three-dimensional print job being made to reduce the processing time of the layer which is not to be printed in a three-dimensional printer.

13. The system of claim 12, wherein the amendment to the three-dimensional print job is made by amending the spacing between objects defined in the three-dimensional print job to be printed.

14. The system of claim 11, wherein the controller is configured to:
pre-process the three-dimensional print job in response to a determination that the three-dimensional print job has a layer which is not to be printed in a three-dimensional printer, the pre-processing of the three-dimensional print job being a processing of the layer which is not to be printed to generate printing instructions for the layer before commencement of printing in a three-dimensional printer.

15. A non-transitory computer-readable medium comprising instructions, which when executed on a computing device, cause the computing device to:
analyse a layer of a three-dimensional print job wherein the value of a parameter relating to the processing time of the layer is determined; and
based on the value of the parameter relating to processing time, determine whether the layer of the three-dimensional print job is to be printed in a three-dimensional printer.
